(19) United States
(12) Patent Application Publication
(10) Pub. No.: US 2006/0157464 A1
(43) Pub. Date: Jul. 20, 2006

(54) Image heating apparatus and heater for use in this apparatus

(75) Inventors: Masahito Omata, Mishima-Shi (JP); Yusuke Nakazono, Mishima-Shi (JP); Yoji Tomoyuki, Tokyo (JP); Satoru Taniguchi, Mishima-Shi (JP); Takeshi Kosuzu, Mishima-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/345,483

(22) Filed: Feb. 2, 2006

Related U.S. Application Data
(63) Continuation of application No. PCT/JP05/20762, filed on Nov. 7, 2005.

(30) Foreign Application Priority Data
Nov. 8, 2004 (JP) 2004-323638
Nov. 2, 2005 (JP) 2005-319529

(51) Int. Cl. H05B 3/00; H05B 1/00

(52) U.S. Cl. 219/216

(57) ABSTRACT

An image heating apparatus which can suppress the excessive temperature rise of the non-sheet passing area of a heater. In an image heating apparatus having a heater generating heat by electrical energization, a flexible member moved while contacting with the heater, and a backup member cooperating with the heater with the flexible member interposed therebetween to form a nip portion, and for heating a recording material bearing an image thereon while nipping and conveying the recording material between the flexible member and the backup member, the heater is constructed by heat-treating a raw material containing an organic matter in an atmosphere wherein carbon is hardly oxidized to thereby carbonize the organic matter.

This application is a continuation of International Application No. PCT/JP2005/020762, filed Nov. 7, 2005, which claims the benefit of Japanese Patent Application No. 2004-323638, filed Nov. 8, 2004 and Japanese Patent Application No. 2005-319529, filed Nov. 2, 2005.

### BACKGROUND OF THE INVENTION

1. Field of the Invention

The invention relates to an image heating apparatus suitable for use as an image fixing apparatus mounted on an image forming apparatus such as, for example, an electrophotographic copying machine or an electrophotographic printer, and a heater for use in this apparatus. The present invention relates particularly to an image heating apparatus having a heater generating heat by electrical energization, a flexible member moved while contacting with the heater, and a backup member cooperating with the heater with the flexible member interposed therebetween to form a nip portion, and for heating a recording material bearing an image thereon while nipping and conveying the recording material between the flexible member and the backup member, and a heater for use in this apparatus.

### RELATED BACKGROUND ART

As an image heating apparatus (fixing device) mounted on a printer or copying machine of an electrophotographic printing method, there is one having a heater having a heat generating resistor on a substrate made of ceramics, a flexible member moved while contacting with this heater, and a pressure roller cooperating with the heater with the flexible member interposed therebetween to form a nip portion. Fixing apparatuses of this type are described in Japanese Patent Application Laid-open No. S63-313182 and Japanese Patent Application Laid-open No. H4-44075. A recording material bearing an unfixed toner image thereon is heated while being nipped and conveyed by the nip portion of a fixing device, whereby the image on the recording material is heated and fixed on the recording material. This fixing device has the merit that the time required from after the electrical energization of the heater has been started until the heater rises to a temperature capable of fixing is short. Accordingly, a printer mounting this fixing device thereon can shorten the time from after the inputting of a printing command until the first sheet of image is outputted (first printout time: FPOT). Also, the fixing device of this type has the merit that electric power consumption during a standby time when it waits for the printing command is small.

Now, it is known that when recording materials of a small size are continuously printed at the same print intervals as for recording materials of a large size by a printer mounting thereon a fixing device using a flexible member, that a temperature of an area of a heater on which the recording materials do not pass (non-sheet passing area) excessively rises. When the temperature of the non-sheet passing area of the heater excessively rises, a holder holding the heater and a pressure roller may in some cases be damaged by heat.

So, a printer mounting thereon a fixing device forming a fixing nip portion by a heater and a pressure roller with a flexible member interposed therebetween effects the control of more widening print intervals when it continuously prints on recording materials of a small size than when it continuously prints on recording materials of a large size, thereby reducing the excessive temperature rise of the non-sheet passing area of the heater.

However, the control of widening the print intervals decreases the number of output sheets per unit time, and it is desired to reduce the number of output sheets per unit time to a degree equal to or somewhat smaller than that in the case of recording materials of a large size.

So, it is also conceived to use, as a heater for use in the above-described fixing device, a heater having the characteristic that the higher becomes the temperature, the lower becomes the resistance value (negative temperature coefficient: NTC) (Japanese Patent Application Laid-open No. 2004-234998). This is the conception that if the heater is of the NTC characteristic, the resistance value of the non-sheet passing area lowers even if the non-sheet passing area excessively rises in temperature, and therefore the excessive temperature rise of the non-sheet passing area can be reduced.

However, it is desired to provide a heater which can better suppress the temperature rise of the non-sheet passing area than the heater disclosed in Japanese Patent Application; Laid-open No. 2004-234998.

Japanese Patent No. 3173800 discloses a carbon heat generating member for use in a heating furnace and a method of manufacturing the same. Japanese Patent Application Laid-open No. 2002-372880 discloses a fixing apparatus having a carbon heat generating member.

However, the heating apparatus and the fixing apparatus described in Japanese Patent No. 3173800 and Japanese Patent Application Laid-open No. 2002-372880 are apparatuses for heating an object to be heated through an air layer. Accordingly, these patent publications do not suppose an image heating apparatus having a flexible member of which one side contacts with a recording material and the other side contacts with a heater, i.e., an image heating apparatus in which the excessive temperature rise of the non-sheet passing area of a heater occurs.

### SUMMARY OF THE INVENTION

The present invention for solving the above-noted problem provides an image heating apparatus having a heater generating heat by electrical energization, a flexible member moved while contacting with the heater, and a backup member cooperating with the heater with the flexible member interposed therebetween to form a nip portion, and for heating a recording material bearing an image thereon while nipping and conveying the recording material between the flexible member and the backup member, wherein the heater is made by heat-treating a raw material containing an organic matter in an atmosphere in which carbon is hardly oxidized to thereby carbonize the organic matter.

Also, the present invention provides an image heating apparatus having a heater generating heat by electrical energization, a flexible member moved while contacting with the heater, and a backup member cooperating with the heater with the flexible member interposed therebetween to form a nip portion, and for heating a recording material bearing an image thereon while nipping and conveying the recording material between the flexible member and the backup member, wherein the heater is a carbon heat generating member utilizing carbon as an electrically conducting substance, and when the heater is thermogravimetrically analyzed at a temperature rising speed of 10° C./min. in the air, the peak of the time derivative (%/min.) of the rate of change in weight (%) of carbon is at 750° C. or lower.

Also, the present invention provides a heater for use in an image heating apparatus having a heater generating heat by electrical energization, a flexible member moved while contacting with the heater, and a backup member cooperating with the heater with the flexible member interposed therebetween to form a nip portion, wherein the heater is a carbon heat generating member utilizing carbon as an electrically conducting substance, and when the heater is thermogravimetrically analyzed at a temperature rising speed of 10° C./min. in the air, the peak of the time derivative (%/min.) of the rate of change in weight (%) of carbon is at 750° C. or lower.

According to the present invention, the excessive temperature rise of the non-sheet passing area of the heater can be suppressed.

### BRIEF DESCRIPTION OF THE DRAWINGS

FIG. 1 is an illustration of the construction of an image forming apparatus in Embodiment 1.

FIG. 2 is a transverse cross-sectional model view of the essential portions of a heating and fixing apparatus according to Embodiment 1.

FIG. 3 is a perspective model view of the same essential portions.

FIG. 4A is a front model view of a stay, and FIG. 4B is a bottom model view thereof.

FIG. 5 is a perspective model view of a carbon heat generating member as a heat source.

FIG. 6 is a perspective model view of the carbon heat generating member with electric power supplying electrodes mounted on the opposite end portions thereof.

FIG. 7 is a bottom model view of the stay with the carbon heat generating member fixedly supported thereby.

FIG. 8 is a block diagram of an electric power supply controlling system for the carbon heat generating member.

FIG. 9 is a model view of the carbon heat generating member.

FIG. 10 shows the resistance-temperature characteristics of the heater examples of Embodiment 1 and a conventional heater example.

FIGS. 11A and 11B are illustrations of the conventional heater.

FIG. 12 is a cross-sectional view showing the arrangement of a heater, a PPS substrate and a stay in Embodiment 2.

FIG. 13 shows the result of the thermogravimetric analysis (TGA) of the respective heater examples in Embodiment 1.

FIG. 14 shows a measuring apparatus for the resistance-temperature characteristic of the heater.

### DESCRIPTION OF THE PREFERRED EMBODIMENTS

### Embodiment 1

(1) Example of an Image Forming Apparatus

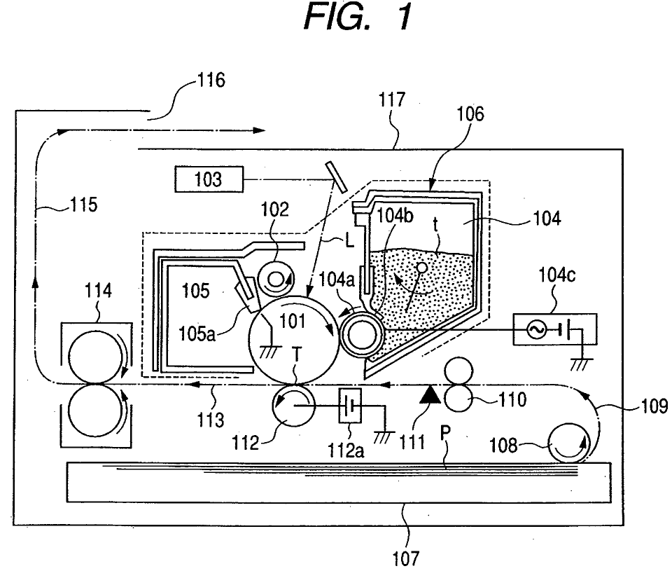

FIG. 1 schematically shows the construction of an image forming apparatus mounting the image heating apparatus of the present invention thereon. This image forming apparatus is a laser beam printer using a transfer type electrophotographic process.

The reference numeral 101 designates a drum-shaped electrophotographic photosensitive member (hereinafter referred to as the photosensitive drum) as an image bearing member. It is, for example, an organic photosensitive drum comprising an electrically conductive drum base of aluminum or the like and a photosensitive layer of an organic photoconductor or the like formed on the outer peripheral surface thereof.

The reference numeral 102 denotes a charging roller as charging means. The surface of the photosensitive drum is uniformly charged to a predetermined polarity and predetermined potential by this charging roller 102. In the printer in the present embodiment, it is uniformly charged to predetermined potential of the negative polarity.

The reference numeral 103 designates a laser exposing apparatus. This laser exposing apparatus 103 outputs a laser beam L modulated correspondingly to image information inputted from an external device (host device) such as an image scanner or a computer (not shown). The uniformly charged surface of the photosensitive drum 101 is scanned by and exposed to this laser beam L. By this scanning and exposure, the charges of the exposed light portion of the surface of the photosensitive drum are attenuated or eliminated, and an electrostatic latent image corresponding to the image information is formed on the surface of the photosensitive drum.

The reference numeral 104 denotes a developing apparatus. The electrostatic latent image formed on the surface of the photosensitive drum is visualized as a toner image by this developing apparatus 104. In the case of a laser beam printer, use is generally be made of a reversal developing method of causing a toner to adhere to the exposed light portion of the electrostatic latent image to thereby develop the latent image. The reference character 104a designates a developing sleeve, the reference character 104b denotes a developing blade, the reference character 104c designates a developing bias applying voltage source, and the letter “t” denotes a monocomponent magnetic toner.

The reference numeral 107 designates a sheet supplying cassette containing recording materials (transfer materials) P therein. A sheet feeding roller 108 is driven on the basis of a sheet feed starting signal, and the recording materials P in the sheet supplying cassette 107 are separated and fed one by one. The thus fed recording material P passes a sheet path 109, registration rollers 110 and a top sensor 111, and is introduced into a transferring region T which is the contact nip portion between the photosensitive drum 101 and a transfer roller 112 at predetermined control timing. That is, the conveyance timing of the recording material P is controlled by the registration rollers 110 so that when the leading edge region of the toner image on the photosensitive drum 101 has arrived at the transferring position T, the leading edge region of the recording material P also arrives at the transferring position T. Also, image writing start timing for the photosensitive drum 101 is controlled On the basis of a recording material leading edge passage detection signal by the top sensor 111.

The recording material P introduced into the transferring region T is nipped and conveyed by this transferring region T and in the meantime, a transferring bias of predetermined potential of a polarity opposite to the charging polarity of the toner is applied from a transferring bias applying voltage source 112a to the transfer roller 112. Thereby, in the transferring region T, the toner image on the surface of the photosensitive drum is sequentially electrostatically transferred onto the surface of the recording material.

The recording material P which has received the transfer of the toner image in the transferring region T is separated from the surface of the photosensitive drum, and thereafter passes on a sheet path 113 and is conveyed and introduced into a fixing apparatus 114 which is an image heating apparatus, where it is subjected to a heat-fixing process for the toner image.

On the other hand, the surface of the photosensitive drum after the separation of the recording material therefrom (after the transfer of the toner image to the recording material) is cleaned by being subjected to the removal of adhering substances such as any untransferred residual toner and paper dust by the cleaning blade 105a of a cleaning apparatus 105, and is repeatedly used for image forming.

Also, the recording material P which has passed through the fixing apparatus 114 passes on a sheet path 115, and is discharged from a sheet discharge port 116 onto a sheet discharging tray 117 on the upper surface of the printer.

In the printer in the present embodiment, four process equipments, i.e., the photosensitive drum 101, the charging roller 102, the developing apparatus 104 and the cleaning apparatus 105 are collectively constructed as an interchangeable process cartridge 106 detachably mountable with respect to a printer main body.

(2) Fixing Apparatus (Image Heating Apparatus) 114

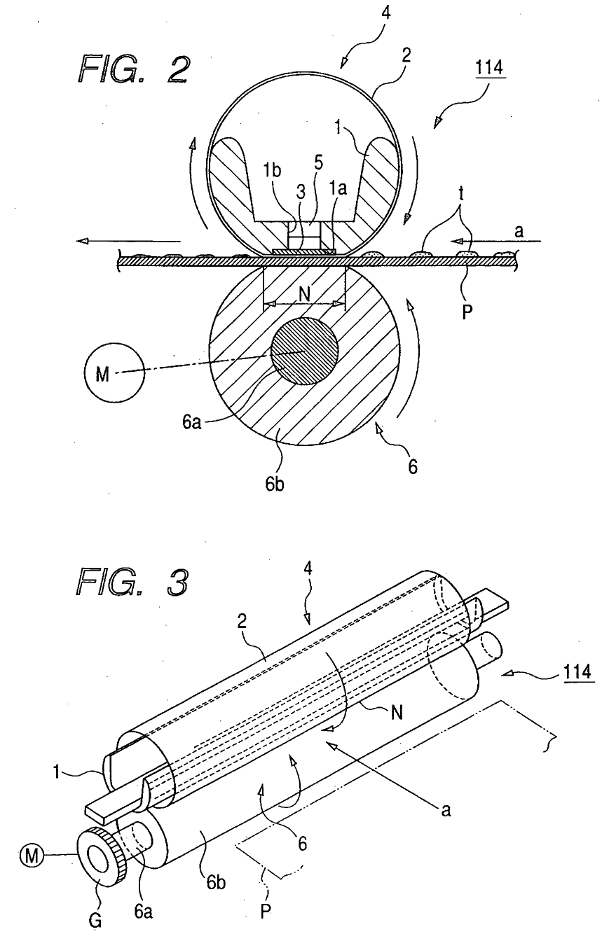

FIG. 2 is a typical transverse cross-sectional view of the essential portions of the fixing apparatus 114 in the present embodiment, and FIG. 3 is a perspective model view of the essential portions thereof. This apparatus is an image heating apparatus of a tensionless type using a film heating method disclosed in Japanese Patent Applications Laid-open Nos. H4-44075 to 44083 and Japanese Patent Applications Laid-open Nos. H4-204980 to 204984.

The image heating apparatus of the tensionless type using the film heating method an apparatus which uses endless belt-shaped or cylindrical heat-resisting film as a flexible member, and in which at least a portion of the circumferential length of this film is made tension-free (a state in which no tension is applied), and the film is adapted to be rotatively driven by the rotatively driving force of a pressure member.

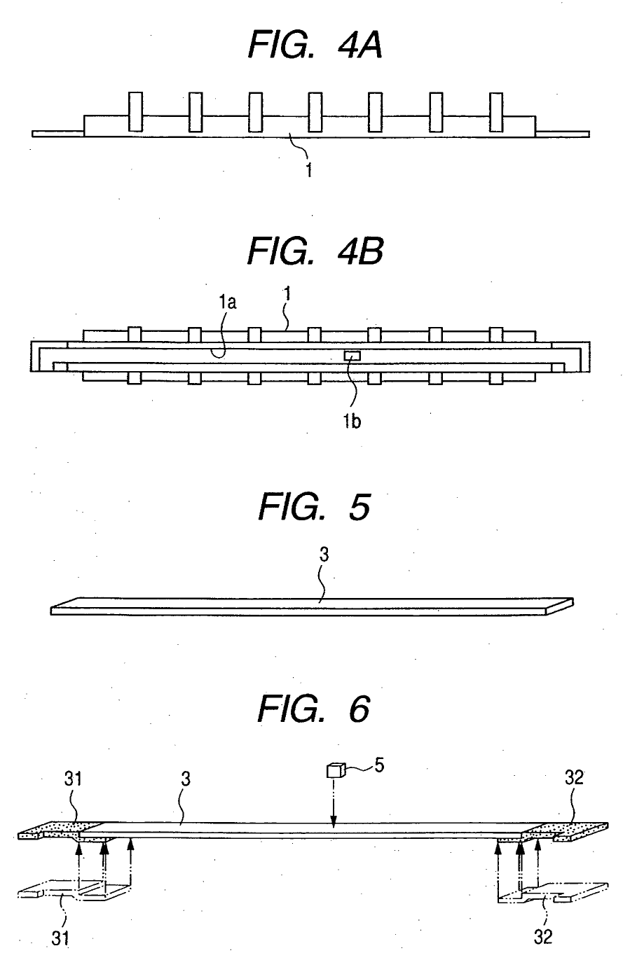

The reference numeral 1 designates a stay as a heat generating member supporting member and film guide member, and it is a rigid member having a substantially semicircular trough-shaped transverse cross-section in which a direction crossing a recording material conveying direction “a” on the surface of a conveying path for the recording material P is longitudinal, and made of heat-resisting resin. In the present embodiment, a highly heat-resistant liquid crystal polymer is used as the material of the stay 1. FIG. 4A is a front view of this stay 1, and FIG. 4B is an underside view (bottom view) thereof.

The reference numeral 3 denotes a heat generating member (heater) fixedly supported by being fitted into a groove portion 1a provided in the underside of the stay 1 along the length of the stay. This heat generating member 3 is a carbon heat generating member. The carbon heat generating member will be described in detail under item (3) below.

The reference numeral 2 designates cylindrical film excellent in heat resistance as a flexible member, and it is fitted onto the stay 1 having the heat generating member 3 supported thereby. The inner peripheral length of this film 2 and the outer peripheral length of the stay 1 including the heat generating member 3 are such that the inner peripheral length of the film 2 is made greater by e.g. about 3 mm, and accordingly the film 2 is loosely fitted with a surplus in its peripheral length.

As regards the film 2, in order to make the heat capacity thereof small to thereby improve the quick starting property thereof, the total film thickness of the film 2 is made equal to 100 μm or less, and as the film 2, use can be made of single-layer film of PTFE, PFA or FEP having heat resistance, a releasing property, strength, durability, etc., or compound-layer film comprising polyimide, polyamideimide, PEEK, PES, PSS or the like having its outer peripheral surface coated with PTFE, PFA, FEP or the like. In the present embodiment, as the heat-resistant film 2, use is made of polyimide film having a thickness of 50 μm and coated with PTFE having a thickness of 10 μm so as to have a film layer thickness of 60 μm. Grease is applied to the inner peripheral surface side of the film 2 in order to improve the slidability thereof.

A heating assembly 4 is constituted by the stay 1, the heater 3, the film 2, etc.

The reference numeral 6 denotes an elastic pressure roller as a backup member. The pressure roller 6 in the present embodiment comprises a mandrel 6a of iron, stainless steel, aluminum or the like having an outer diameter of 13 mm and covered with a silicone foam having a length of 240 mm and a thickness of 3 mm as a heat-resistant elastic layer 6b. Predetermined pressure is applied to between the heat generating member 3 and the pressure roller 6 (exactly between the stay 1 holding the heat generating member 3 and the pressure roller 6), and a fixing nip portion N of a predetermined width is formed between the heat generating member (heater) 3 on the heating assembly 4 side and the pressure roller 6 with the film 2 interposed therebetween.

The driving force of a driving mechanism M is transmitted to a drive gear G provided on one end of the mandrel of the pressure roller 6, whereby the pressure roller 6 is rotatively driven at a predetermined peripheral speed in the counter-clockwise direction indicated by the arrow. By the rotative driving of the pressure roller 6, a rotating force acts on the film 2 with the frictional force between the pressure roller 6 and the outer surface of the film in the fixing nip portion N. The film 2 is driven to rotate at substantially the same peripheral speed as the rotational peripheral speed of the pressure roller 6 in the direction indicated by the arrow about the stay 1 while the inner surface side thereof is sliding in close contact with the surface of the heat generating member 3 in the fixing nip portion N. The stay 1 also serves as a guide member for the film 2 drivers to rotate.

Then, in a state in which the temperature of the heater 3 has risen to a predetermined temperature and the rotational peripheral speed of the film 2 has become steady, the recording material P bearing a toner image thereon is introduced into between the film 2 and the pressure roller 6. Then, the recording material P is nipped and conveyed by the fixing nip portion N together with the film 2, whereby the heat of the heat generating member 3 is imparted to the recording material P through the film 2 and the unfixed visualized image (toner image) “t” on the recording material P is heated and fixed on the surface of the recording material P. The recording material P which has passed through the fixing nip portion N is separated from the surface of the film 2 and is conveyed.

(3) Heat Generating Member (Heater) 3

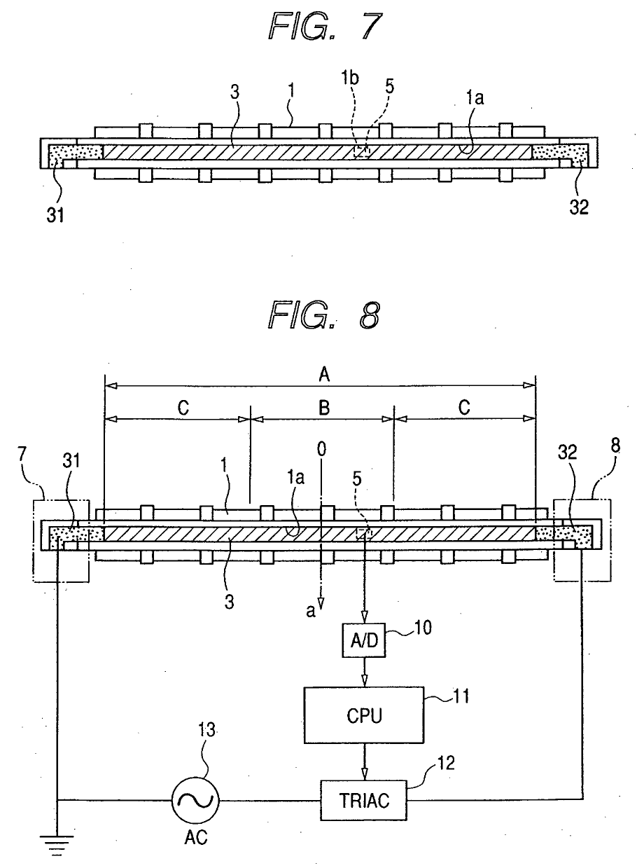

The heat generating member 3 is a carbon heat generating member. FIG. 5 is a pictorial perspective view of the heat generating member 3. The heat generating member 3 in the present embodiment is of the shape of a rectangular parallelepiped having a thickness of 0.5 mm×a width of 5 mm×a length of 250 mm. As shown in FIG. 6, electric power supplying electrodes 31 and 32 are mounted on the longitudinally opposite end portions of the heat generating member 3. Although a method of mounting the electric power supplying electrodes 31 and 32 is not particularly restricted, the electric power supplying electrodes 31 and 32 are connected by silver paste (DOTITE produced by Fujikura Kasei Co., Ltd.) being applied to the opposite end portions of the heat generating member 3. FIG. 7 is an underside view of the stay 1 fixing supported by the heat generating member 3 with the electric power supplying electrodes 31 and 32 mounted thereon being fitted into the groove portion 1a. The heat generating member 3 is attached to the stay 1 so that a direction perpendicular to the recording material conveying direction “a” may be longitudinal.

The reference numeral 5 designates a temperature detecting element for detecting the temperature of the heat generating member 3. In the present embodiment, a thermistor of an abutting type separate from the heat generating member 3 is used as the temperature detecting element 5. This abutting type thermistor 5 assumes a construction in which for example, a chip thermistor element abuts against the back surface of the heat generating member by a predetermined pressure force toward the back surface side of the heat generating member (that side of the heat generating member which is opposite to the film sliding surface side thereof). In the present embodiment, there is adopted a construction in which the thermistor 5 is fitted into a through-hole 1b formed in the bottom surface of the groove portion 1a, into which the heat generating member is fitted, of the stay 1 to thereby directly abut against the back surface of the heat generating member 3. Also, in the longitudinal direction of the fixing apparatus, the thermistor detects the temperature of the heat generating member in the area thereof on which a recording material of a minimum fixed size usable in the image forming apparatus passes.

FIG. 8 is a block diagram of an electric power supply controlling system as electric power supply controlling means to the heat generating member 3. The reference numerals 7 and 8 denote electric power supplying connectors fitted to the electric power supplying electrodes 31 and 32 on the opposite end sides of the heat generating member 3 fixedly supported by the stay 1, and electrical contacts on the connectors 7 and 8 side come into contact with the electric power supplying electrodes 31 and 32, respectively. The electric power supplying connectors 7 and 8 are connected to an electric power supplying portion through an electric power supplying cable.

The heat generating member 3 generates heat in its longitudinal effective heat generating full length area by electric power being supplied from a commercially available power source (AC power source) 13 to between the electrodes 31 and 32 through a triac 12, and quickly and sharply rises in temperature. Then, the temperature of the heat generating member 3 is detected by the thermistor 5, and the output of the thermistor 5 is introduced into an electric power supply-controlling portion (CPU) 11 through an analog/digital converter (A/D) 10. The controlling portion 11 phase-controls or wave-number-controls the triac 12 on the basis of the detected temperature information. The electric power supplied to the heat generating member 3 is thus controlled, whereby the heat generating member 3 is temperature-controlled so as to maintain a desired temperature. That is the electric power supplied to the heat generating member 3 is controlled so that the heat generating member 3 may rise in temperature when the detected temperature by the thermistor 5 is lower than a predetermined set temperature (fixing temperature), and the heat generating member 3 may fall in temperature when the detected temperature by the thermistor 5 is higher than the predetermined set temperature. Thereby, the temperature of the heat generating member 3 during fixing is kept at a predetermined constant temperature. In the present embodiment, the output is changed at 21 stages spaced 5% apart from 0 to 100% by phase control. The output 100% refers to the time when the electric power from the commercially available power source is fully supplied to the heat generating member.

Here, the sheet width is the dimension of the recording material in a direction orthogonal to the recording material conveying direction “a” in the plane of the recording material P. The printer in the present embodiment has the center of the recording material in the width direction thereof as the conveyance standard, and the center of the heat generating member 3 of the fixing apparatus in the longitudinal direction thereof is the conveyance standard of recording materials of various sizes. In FIG. 8, the reference sign “0” denotes the recording material conveyance standard line (imaginary line). The reference sign “A” denotes the sheet passing portion (maximum sheet passing area) for a recording material of a definite maximum sheet width usable in this printer, and substantially corresponds to the effective heat generating full length area of the heat generating member 3 in the longitudinal direction thereof. The reference sign “B” denotes the sheet passing portion (minimum sheet passing area) for a recording material of a definite minimum sheet width usable in the printer. The reference sign “C” denotes a non-sheet passing area occurring in the recording material conveying path surface when a recording material (small-sized sheet) having a sheet width smaller than that of the recording material of the maximum sheet width has been passed. The area width of the non-sheet passing area C differs depending on the magnitude of the sheet width of the passed small-sized sheet.

The thermistor 5 for detecting the temperature of the heat generating member 3 abuts against that area of the heat generating member which corresponds to the minimum sheet passing area B providing a recording material passing area irrespective of the size in the sheet width of the passed recording material.

The heat generating member 3 is a carbon heat generating member utilizing carbon as an electrically conducting substance, and is obtained by heat-treating a raw material containing at least an organic matter in a non-oxidizing atmosphere for carbon (an atmosphere in which carbon is hardly oxidized), and carbonizing the organic matter. The reason for using such a carbon heater is for suppressing the excessive temperature rise of the non-sheet passing area of the heater by the utilization of the characteristic that a rise in temperature results in the fall of the resistance value, that is, the NTC (negative temperature coefficient) characteristic of the heater.

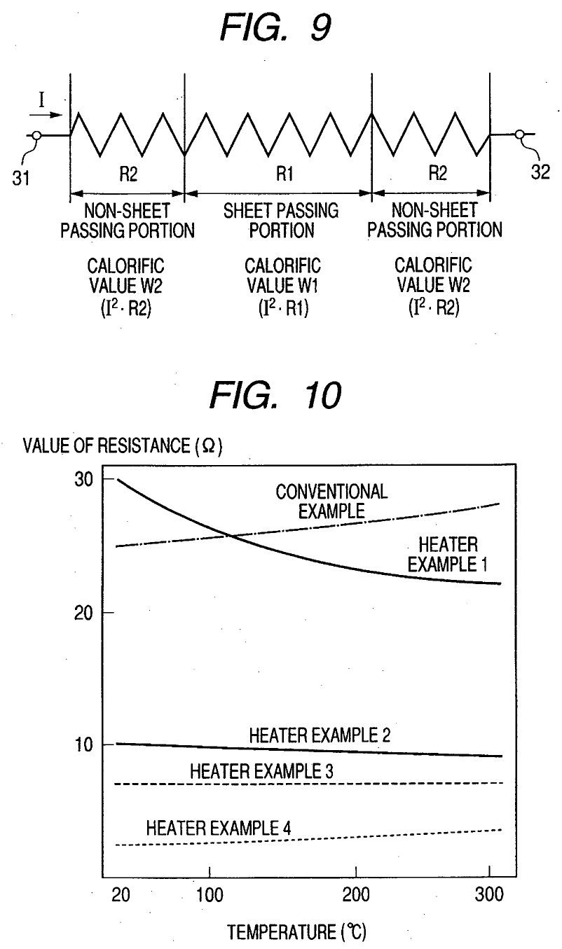

The reason why the use of the heater having the NTC characteristic leads to the capability of reducing the excessive temperature rise of the non-sheet passing area will now be described with reference to FIG. 9.

FIG. 9 is a model view of the heat generating member. In a case where the electric current passing through the heat generating member is defined as I, the resistance value of the central portion (sheet passing area) is defined as R1, and the resistance value of the end portion (one side of the non-sheet passing area) is defined as R2, the calorific value W1 of the central portion is I²·R1, and the calorific value W2 of the end portion is I²·R2. In order to make it readily understood, the sheet passing area and the non-sheet passing area are considered as being comparted by a position at which R1=2×R2 in a state in which the recording material is not passed to the fixing nip portion (a state in which the resistance value per unit length is uniform in the entire heat generating member), that is, a position at which the length of the non-sheet passing area (the sum of the lengths of the opposite end portions) becomes equal to the length of the sheet passing area.

In a PTC (positive temperature coefficient) heat generating member, considering a case where a small-sized sheet has been passed, the heat generating member contacts with the sheet through the film and therefore, the heat of the central portion is taken by an amount corresponding to the width of the small-sized-sheet. The temperature detecting element detects the temperature of the central portion, and electric power supply control is effected so that the temperature of the central portion may not fall and therefore, the end portions from which the heat is not taken by the sheet assume a high temperature relative to the central portion. In this case, due to the PTC characteristic, the resistance value per unit length of the end portions becomes higher than the resistance value per unit length of the central portion and therefore, the calorific value W2 of one end portion becomes great as compared with the calorific value W1 of the central portion. That is, the calorific value per unit length of the end portion increases more than that of the central portion. Also, when the calorific value becomes great, the temperature rises and therefore the resistance becomes still higher, and the calorific value further increases.

On the other hand, in an NTC heat generating member, when a small-sized sheet has been passed, a higher temperature results in a lower resistance value and therefore, the resistance value per unit length of the end portions becomes lower than the resistance value per unit length of the central portion. Consequently, the calorific value W2 of one end portion becomes small as compared with the calorific value W1 of the central portion. That is, the calorific value per unit length of the end portion becomes smaller than that of the central portion. Therefore, the heat generation at the opposite end portions can be suppressed more than in the case of the PTC heat generating member.

By the reason set forth above, if the heat generating member is a resistance heat generating member of the NTC characteristic, the temperature of the end portions during the small-sized sheet passing can be suppressed to a low level.

Now, as described above, the raw material containing an organic matter is heat-treated at a predetermined temperature in the non-oxidizing atmosphere for carbon, whereby carbon can be suppressed from being decomposed and extinguished by oxidization, and the carbonization of the raw material can be progressed.

However, simply by carbonizing a raw material containing an organic matter, it is not always possible to manufacture an appropriate heater as a heater to be mounted on a fixing apparatus using such a flexible member as described above. The reason for this will hereinafter be described.

When the raw material containing an organic matter has been carbonized, there are formed a graphitized portion and a non-graphitized portion (including amorphous carbon). The resistance value ρ of the carbon heat generating member using carbon as an electrical conductor is the sum (ρ=ρi+ρc) of the resistance value ρi of the graphitized portion and the resistance value ρc of the non-graphitized portion (including amorphous carbon).

The single crystal of graphite has the characteristic that a rise in temperature also results in a rise in resistance value, that is, the PTC characteristic, and ρi exhibits the PTC characteristic. In contrast, in a temperature area of 1000° C. or lower, the non-graphitized portion generally has the NTC characteristic, and ρc exhibits the NTC characteristic. Also, the single crystal of graphite is low in resistance value and high in electrical conductivity, but the non-graphitized portion is higher in resistance value and lower in electrical conductivity than the graphitized portion.

Now, the resistance-temperature characteristic of the carbon heat generating member differs depending on the state of progression of graphitization, i.e., the ratio of the graphitized portion and non-graphitized portion occupying the heat generating member. The manner of progression of graphitization depends on the temperature (heat-treating temperature) when heat-treating the raw material containing an organic matter. When the heat-treating temperature is made high, graphitization progresses, and when the heat-treating temperature is made low, graphitization is suppressed and amorphous carbon becomes more.

When graphitization progresses, the influence of ρc is reduced relatively and ρi becomes dominant, and the heat generating member approximate to the PTC characteristic. When conversely, graphitization is suppressed, the influence of ρi is reduced relatively and ρc becomes dominant, and the heat generating member approximates to the NTC characteristic.

Accordingly, if graphitization is suppressed, a heat generating member of the NTC characteristic can be manufactured, but it is not preferable to suppress graphitization too much. This is because considering that the fixing apparatus using the above-described flexible member is connected with an ordinary commercial power source for use, the resistance value of the heat generating member 3 thereof should desirably be within a range of 3Ω or greater and 100Ω or less. If the aforementioned resistance value is greater than 100Ω, it will become difficult to obtain electric power necessary for fixing, and if it is less than 3Ω, an electric power supply controlling mechanism to the heat generating member 3 will become complicated. A heat generating member in which graphitization was suppressed too much becomes very, high in resistance value, and is not suitable as a heat generating member to be mounted on the above-described fixing apparatus.

Consequently, if graphitization is suppressed too much, the heat generating member will not exhibit practical electrical conductivity, but yet by graphitization progressing moderately, ρc becomes dominant, and there can be obtained a heat generating member having the NTC characteristic and having a moderate resistance value.

In such an atmosphere as described above wherein carbon is hardly oxidized, but heat treatment at a moderate temperature, carbon in the raw material can be controlled to structure having a resistance value and a resistance-temperature characteristic appropriate as a heat generating member. By using such a carbon heat generating member (heater) as a heat source, it is possible to reduce the temperature rise of the non-sheet passing portion of the image heating apparatus. Also, it is possible to shorten the rise time of the apparatus. Along therewith, it is possible to realize an increase in the throughput of the image forming apparatus, an up of specs such as FPOT, and a reduction in cost by the use of heat-resisting grade-down parts.

In the present embodiment, particularly as the organic matter to be carbonized, use is made of an organic matter exhibiting a carbonization yield of 5% or greater by heat treatment in a non-oxidizing atmosphere, e.g. in vacuum or in an inert gas such as nitrogen gas or argon. As such organic matter there is, for example, thermoplastic resin such as chlorinated vinyl chloride resin, polyvinyl chloride, polyacrylonitrile, polyvinyl alcohol, polyvinyl chloride-polyvinyl acetate copolymer or polyamide, thermosetting resin such as phenol resin, furan resin, epoxy resin, unsaturated polyester resin or polyimide, or a natural high molecular substance having a condensed polycyclic aromatic material in the basic structure of a molecule, such as lignin, cellulose, tragacanth gum, gum arabic or saccharides. Besides these, mention may be made of a synthetic high molecular substance having a condensed polycyclic aromatic material in the basic structure of a molecule, such as the formation condensate of naphthalene sulfonic acid or COPNA resin.

The aforementioned non-oxidizing atmosphere for carbon (the atmosphere in which carbon is hardly oxidized) refers to vacuum (1×10⁻² Pa or less), or nitrogen gas or an inert gas. By effecting heat treatment in such an atmosphere, the oxidization during the heat treatment can be reliably prevented, and a carbon heat generating member can be stably made.

The carbonization yield mentioned herein means the ratio between the weight of a carbonized substance (a complex such as graphite or amorphous carbon) obtained by heat treatment in the non-oxidizing atmosphere and the weight of the organic matter in the raw material before heat-treated. Accordingly, for example, a carbonization yield of 5% means that when the weight of the organic matter before heat treatment is 100 g, the weight of the carbonized substance after heat treatment is 5 g. Incidentally, when an organic matter is heat-treated in an oxidizing atmosphere, although depending on the kind of the organic matter used, oxidization generally begins from a heat treating temperature of about 500° C. Since oxidization occurs, carbon is decomposed or burned out, and even if the heat treating temperature is raised any further, the organic matter is decomposed or burned out, sufficient carbonization does not progress (other, components than carbon are not sufficiently decomposed, and graphitization does not progress). Consequently, there cannot be obtained a stable carbonized substance which can be utilized as a heater. The kind and amount of the organic matter used are suitably selected by the resistance-temperature characteristic, resistance value and shape of the heat generating member, and the organic matter can be used in the form of one kind of organic matter or a mixture of several kinds of organic matters.

Also, carbon powder may be mixed with the organic matter in advance. As the, carbon powder mentioned herein, there is carbon black, graphite, coke or the like, and depending on the resistance value and shape of the heat generating member, it can be used as one kind or a mixture of several kinds. In this case, electrons pass through the carbon powder mixed in advance and in the organic matter carbonized by heat treatment. The technique of mixing carbon powder with the raw material in advance is effective when it is desired to reduce the volume resistance of the heat generating member.

Also, to make a heat generating member of any resistance value, it is desirable to heat-treat a raw material consisting of an insulative substance or a semi-electrically conductive substance mixed with an organic matter. Preferable as the insulative or semi-electrically conductive substance is a metal carbide, a metal boride, a metal silicide, a metal nitride, a metal oxide, a semi-metal nitride, a semi-metal oxide or a semi-metal carbide, and one kind or several kinds can be selected by the resistance value and shape of the heat generating member.

The raw material with which the insulative substance or the semi-electrically conductive substance is mixed has therein not only carbon but also an insulative or semi-electrically conductive substance which is an electrical conduction hindering substance for electrons passing through the carbon and therefore, a heat generating member of a desired resistance value can be manufactured easily. By using these techniques, the degree of freedom of the resistance value and assumable shape of the heat generating member is widened.

That is, the organic matter to be carbonized by heat treatment and one kind or several kinds of at least insulative or semi-electrically conductive substances-are mixed together. If then, the mixture is molded, and thereafter is heat-treated in a non-oxidizing atmosphere for carbon to thereby make a carbon heat generating member 3, the set latitude of the resistance-temperature characteristic, the resistance value and the shape of the heat generating member is widened. Accordingly, a heat generating member suited for a fixing apparatus using a flexible member can be provided easily. As required, not only the insulative substance or the semi-electrically conductive substance, but also carbon powder may be mixed with the raw material.

Also, boron nitride, alumina, silicon carbide, boron carbide or the like is recommended as the insulative substance or the semi-electrically conductive substance. By using such a substance, it is possible to effect the control of the resistance value of the heat generating member easily.

Also, it is preferable that the heat treating temperature during the heat treatment of the carbon heat generating member (the highest reached temperature during heat treatment) be 850° C. or higher and 1750° C. or lower. By heat-treating at the above-mentioned temperature, it becomes possible to make the rate of change in the resistance of the carbon heat generating member nearly zero or negative. Also, it becomes possible to adjust the resistance value of the carbon heat generating member to a practical resistance value, and it is possible to provide a heat-fixing apparatus free of the excess and deficiency of the suppression of the temperature rise of the non-sheet passing portion and electric power.

Graphitization is adjustable to a certain degree even by the kinds of the organic matter to be heat-treated and the carbon powder mixed with the raw material and the put-in amount thereof, but depends greatly on the condition of the heat treatment of the organic matter to be graphitized, and particularly the higher is the heat-treating temperature, the higher becomes the degree of graphitization.

As described above, the carbon heat generating member has the feature that simply by changing the condition of heat treatment and adjusting the graphitization, the resistance-temperature characteristic thereof can be greatly changed with ease.

As required, other desired functional layer such as a heat-resistant lubricating material layer can also be added to the film sliding surface of the carbon heat generating member 3.

(4) Various Specific Examples of the Heat

Generating Member 3

Some specific examples of the heat generating member (hereinafter referred to as the heater) in the present embodiment will be shown, below. Heater Example 1 to Heater Example 4 are the same in the raw material before heat treatment, but differ in the heat treating temperature from one another.

### HEATER EXAMPLE 1

In this example of the heater (carbon heat generating member), chlorinated vinyl chloride resin, graphite powder and boron nitride were dispersed and kneaded, and the mixture was molded into a bar shape by an extrusion molding machine, whereafter it was heat treated at 1500° C. in a vacuum (0.01 Pa or less). Thereby, there was obtained a base material having specific resistance of 30.1×10⁻³ Ω·cm in a room temperature environment (20° C.). This base material was worked into a shape of length 250 mm×width 5 mm×thickness 0.5 mm, having a total resistance value of 30.1 Ω.

Now, the load deformation temperature of a liquid crystal polymer used for the heater support member (the stay 1 in the present embodiment) is in the vicinity of 300° C. Also, the fusing point of fluorine resin such as PFA or PTFE used as the material of the surface layer of the film (flexible member) frictionally contacting with the heater, and the surface layer of the pressure roller contacting with the surface layer of the film is in the vicinity of 300° C. Consequently, when the temperature of the heater rises to about 300° C., there is the possibility of the fixing apparatus being damaged. So, the transition of the resistance value of the heater within a temperature range of a room temperature to 300° C. was examined.

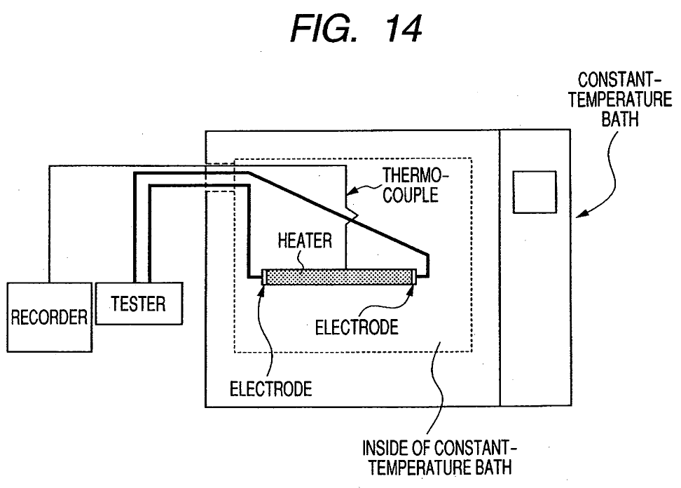

FIG. 10 shows the resistance-temperature characteristics of four heater examples in the present embodiment and a conventional heater. The measurement of the resistance-temperature characteristics was effected by putting a heater with an electrode and a thermocouple for resistance measurement attached thereto into a constant-temperature bath, as shown in FIG. 14, connecting the lead wires of an electrode and a thermocouple for heater measurement to a tester and a recorder installed outside the constant-temperature bath, and monitoring the warming-up state of the heater. In order to measure the resistance value in a state in which the temperature of the heater has reached a uniform and constant temperature (the temperature in the constant-temperature bath), the inside of the constant-temperature bath in which the heater was put was kept at a measurement temperature for 10 minutes or longer, whereafter the resistance value of the heater was measured.

Here, in order to compare the resistance-temperature characteristics of the heaters intelligibly, the rate of change in resistance D(X° C.) of the heater at a temperature X° C. is defined as follows:
D(X° C.)=(R(X° C.)−R(20° C.))/R(20° C.),
where R(X° C.) means the resistance value of the heater at X° C. Also, R(20° C.) is the resistance value of the heater when the temperature of the heater is 20° C.

Thereupon, in the case of Heater Example 1, as can be seen from FIG. 10, the rate of change in resistance D(X° C.) is always negative in the temperature area of the room temperature to 300° C.

Incidentally, the rate of change in resistance of Heater Example 1 at 300° C. was [(resistance value at 300° C.=21.95Ω)/(resistance value of room temperature environment=30.1Ω)−1]=−0.271.

That is, it can be seen that Heater Example 1 has the NTC characteristic within a temperature range of 20° C. to 300° C.

### HEATER EXAMPLE 2

In the same manner as in Embodiment 1 with the exception that the heat treating temperature in the vacuum was 1650° C., there was obtained a base material having specific resistance of 10×10 Ω·cm in a room temperature environment (20° C.). This base material was worked into a shape of length 250 mm×width 5 mm thickness 0.5 mm, having a total resistance value of 10 Ω. Also, as the resistance temperature characteristic of the present Heater Example 2 in FIG. 10 shows, the rate of change in resistance of this heater is always negative in the temperature area of the room temperature to 300° C.

Incidentally, the rate of change in resistance of the present Heater Example 2 was found to be [(resistance value at 300° C.=9.15Ω)/(resistance value of room temperature environment=10Ω)−1]≈−0.085.

That is, it can be seen that Heater Example 2 has the NTC characteristic within a temperature range of 20° C. to 300° C.

### HEATER EXAMPLE 3

In the same manner as in Embodiment 1 with the exception that the heat treating temperature in the vacuum was 1750° C., there was obtained a base material having specific resistance of 7.0×10⁻³ Ω·cm in a room temperature environment (20° C.). This base material was worked into a shape of length 250 mm×width 5 mm×thickness 0.5 mm, having a total resistance value of 7.0Ω. Also, as the resistance temperature characteristic of the present Heater Example 3 in FIG. 10 shows, the rate of change in resistance of the present heat generating member is a value substantially in the vicinity of zero in the temperature area of the room temperature to 300° C. Incidentally, the rate of change in resistance of this Heater Example 3 was found to be [(resistance value at 300° C.=6.95Ω)/(resistance value of room temperature environment=7.0Ω)−1]≈−0.007.

That is, it can be seen that Heater Example 3 has the NTC characteristic within a temperature range of 20° C. to 300° C.

### HEATER EXAMPLE 4

In Heater Example 4, chlorinated vinyl chloride resin, graphite powder and boron nitride were dispersed and kneaded, and were molded into a bar shape by an extrusion molding machine, and thereafter were heat-treated at 2200° C. in a vacuum (0.01 Pa or less). Thereby, there was obtained a base material having specific resistance of 2.5×10⁻³ Ω·cm in a room temperature environment (20° C.).

This base material was worked into a shape of length 250 mm×width 5 mm×thickness 0.5 mm, having a total resistance value of 2.5Ω. Also, as the resistance-temperature characteristic of Heater Example 4 in FIG. 10 shows, the rate of change in resistance of Heater Example 4 is always positive in the temperature area of the room temperature to 300° C.

Incidentally, the rate of change in resistance of the present Heater Example was found to be [(resistance value at 300° C.=2.65Ω)/(resistance value of room temperature environment=2.5Ω)−1]≈+0.06.

That is, it can be seen that Heater Example 4 does not have the NTC characteristic within the temperature range of 20° C. to 300° C., but somewhat has the PTC characteristic. However, as is apparent from FIG. 10, it is smaller in the PTC characteristic than the conventional heater.

Next, Table 1 below shows the result of the measurement of the temperature rise of the non-sheet passing portion of the pressure roller 6 carried out with each of the heaters of Heater Examples 1 to 4 mounted on the heat-fixing apparatus 114 of the aforedescribed film heating type. The test method for the temperature rise of the non-sheet passing portion was carried out with the process speed of the image forming apparatus being constant at 120 mm/sec., and twenty envelopes (COM10) as small-sized sheets being continuously passed at three kinds of sheet passing intervals, i.e., 10 ppm, 8 ppm and 6 ppm.

### CONVENTIONAL EXAMPLE

This example, as a comparative example, is the case of a fixing apparatus of a film heating type using a conventional ceramic heater as a heat source.

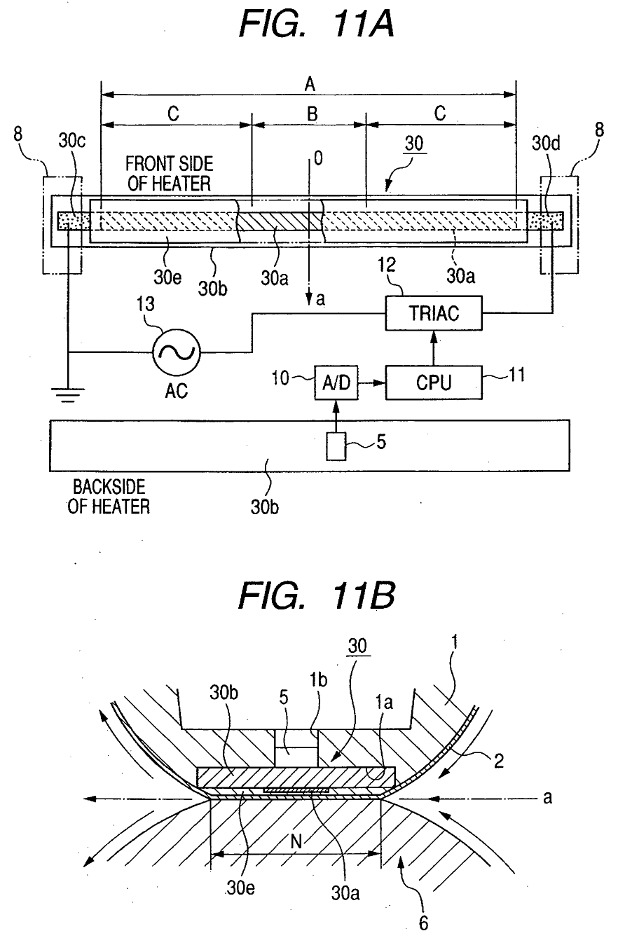

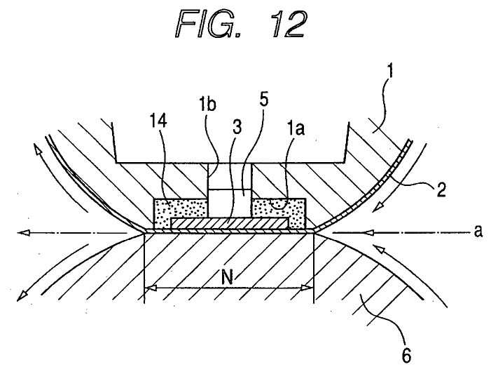

FIG. 11A shows the construction of a ceramic heater 30 used in this example and a block diagram of an electric power supply control unit system. FIG. 11B is an enlarged transverse cross-sectional model view of the fixing nip portion of the fixing apparatus of the film heating type using this ceramic heater 30 as a heat source. The basic construction of the fixing apparatus of the film heating type is the same as that of the fixing apparatus of Embodiment 1 except for the heater and therefore, constituent members and portions common to those of the fixing apparatus of Embodiment 1 are given common reference characters and need not be described again.

The conventional ceramic heater 30 used in this conventional example is of a construction in which a resistance heat generating member 30a of Ag/Pd or the like, electrodes 30c, 30d and a glass protective layer 30e are formed on an alumina ceramic substrate 30b by screen printing.

Incidentally, the resistance value (under a room temperature environment of 20° C.) of the resistance heat generating member 30a of this conventional example is 25.1Ω, and the rate of change in resistance of the resistance heat generating member 30a at 300° C. was found to be [(resistance value at 300° C.=29.0Ω)/(resistance value in room temperature environment=25.1Ω)−1]≈+0.155.

As a method of measuring the temperature rise of a pressure roller in this comparison, the measurement of the temperature of the non-sheet passing portion was effected by the use of thermography, and the highest temperature value was compared.

When the conventional heater 30 used in this comparison was temperature-controlled so as to maintain 185° C., the fixing property was the same as that in the 180° C. temperature control of Heater Examples 1 to 4. Consequently, sheets were passed at that controlled temperature and a comparison test was carried out.

TABLE 1
Comparison of Temperature Rise of Non-Sheet Passing Portion
between Embodiment 1 Construction and Conventional Example

| | temperature rise | temperature rise | temperature rise |
|---|---|---|---|
| | 6 ppm of non- | 8 ppm of non- | 10 ppm of non- |
| | sheet passing | sheet passing | sheet passing |
| | portion (highest | portion (highest | portion (highest |
| | temperature of | temperature of | temperature of |
| | surface of | surface of | surface of |
| | pressure roller) | pressure roller) | pressure roller) |
| Conventional | 232° C. | 257° C. | 285° C. |
| Example | | | |
| Heater | 191° C. | 210° C. | 230° C. |
| Example 1 | | | |
| Heater | 200° C. | 218° C. | 239° C. |
| Example 2 | | | |
| Heater | 210° C. | 229° C. | 255° C. |
| Example 3 | | | |
| Heater | 222° C. | 238° C. | 268° C. |
| Example 4 | | | |

As can be seen from Table 1 above, great differences occur among the values of the temperature rise of the non-sheet passing portion, depending on the resistance-temperature characteristics of the heaters. It will be seen that as in Heater Example 4, even if the resistance-temperature characteristic is not NTC, if the value of the PTC resistance temperature characteristic is lower than in the conventional example, it is effective. Also, it will be seen that as in Heater Example 1 to Heater Example 4, the smaller becomes the value of the resistance-temperature characteristic (the greater becomes the tendency of NTC), the more effective it is for the suppression of the temperature rise of the non-sheet passing portion.

According to the inventors' study, it has been found that if D(X° C.)≦0.15 within the temperature range of the heater of 20° C. or higher and 300° C. or lower, there is the effect of suppressing the excessive temperature rise of the non-sheet passing portion. It has been found that it is more preferable to manufacture the heater so that D(X° C.)≦0 within the temperature range of the heater of 20° C. or higher and 300° C. or lower.

The reason why as in Heater. Example 1 to Heater Example 4, great differences occur in the resistance-temperature characteristic between heaters differing in heat treating temperature is that when the heat treating temperature is high (1750° C. or higher), the graphitization of the carbon heat generating member progresses and the rate of influence given from the resistance value ρi of the graphitized portion to the resistance of the whole becomes great, and that when conversely, the heat treating temperature is low (lower than 1750° C. to 850° C. or higher), graphitization stops in a moderately progressed state and therefore, the rate of influence given from the resistance value ρc of the non-graphitized portion (including an amorphous carbon portion) to the resistance of the whole becomes great. Incidentally, when the heat treating temperature is lower than 850° C., graphitization does not progress much and a practical resistance value is not reached.

Now, between graphitized carbon and non-graphitized amorphous carbon or the like, the ease with which thermal decomposition is done differs. Generally, graphite is thermally more stable and amorphous carbon is easier to decompose. Accordingly, the degree of progression of graphitization can be discriminated if for example, as in the thermogravimetric analysis (TGA), a change in the weight of heater (the manner of being decomposed) when heat is applied to the heater is measured.

So, Heater Examples 1 to 4 described above were thermogravimetrically analyzed to thereby examine the degree of progression of the graphitization of each heater.

As described above, amorphous carbon is easier to thermally decompose in the air than graphite, and the ease with which it is thermally decomposed is changed by the manner of progression of the graphitization of the carbon heat generating member. Particularly, the manner of progression of graphitization appears as a difference in the maximum value of the rate of change in weight when the thermogravimetric analysis is effected, i.e., the peak position in the derivative curve of a change in weight. Consequently, the carbon heat generating member having the NTC characteristic can be assigned by effecting a thermogravimetric analysis.

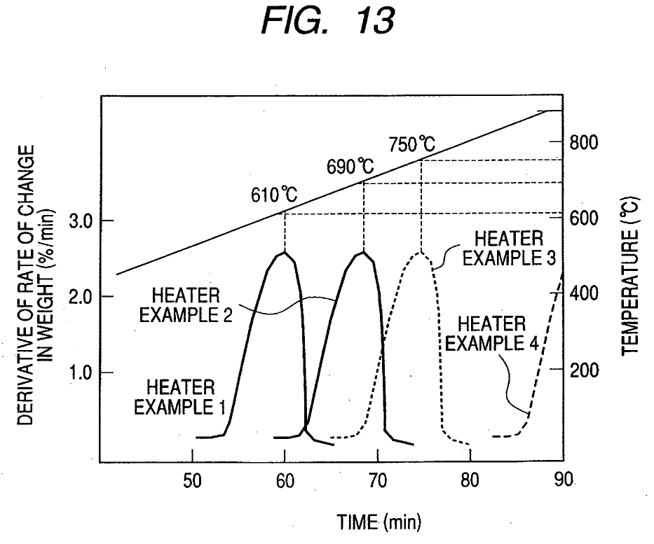

FIG. 13 shows the result of a thermogravimetric analysis effected on Heater Examples 1 to 4. For the thermogravimetric analysis, use was made of thermogravimetric Q600 produced by TA Instrument Co., Inc. (U.S.) As the sample temperature rise speed of the thermogravimeter, temperature was raised from a room temperature environment (20° C.) to 900° C. at 10° C./min. Also, TGA was carried out after each of Heater Examples 1 to 4 was likewise crushed.

As can be seen from FIG. 13, in Heater Examples 1 to 3 wherein D(300° C.) is negative, the temperature value at the peak (maximum portion) in the derivative curve (%/min.) of the change in weight of TGA (hereinafter referred to as the decomposition peak temperature value) is at 750° C. or lower. Also, it can be seen that the greater is the tendency of NTC, the lower the decomposition peak temperature value tends to become. This shows that in a heater wherein the tendency of NTC is great, the rate amorphous carbon relatively easy to thermally decompose occupies is great and therefore, thermal decomposition is liable to occur on the low temperature side. It can be further seen that in Heater Example 4 having not the NTC characteristic, the peak is not at 900° C. or lower. Consequently, it can be seen that it is preferable to manufacture such a heater that the peak of the time derivative (%/min.) of the rate of change in weight of carbon is 750° C. or lower when the heater is thermogravimetrically analyzed at a temperature rise speed of 10° C./min. in the air. One of conditions for manufacturing such a heater is that as previously described, the temperature when heat-treating the raw material containing an organic matter is 850° C. or higher and 1750° C. or lower.

The number of the peaks of the time derivative curve of the rate of change in thermogravity of each of Heater Examples 1 to 3 in the present Embodiment 1 was only one. However, if for example, Heater Example 2 is crushed and the powder thereof is mixed with Heater Example 1 before heat treatment and the mixture is sintered under the condition of Heater Example 1, graphitization does not progress any further under the condition of Heater Example 1 because the powder of Heater Example 2 has already been treated at a temperature higher than the sintering condition of Heater Example 1. Therefore, the resultant heater is a mixture of Heater Examples 1 and 2 and therefore, two peaks appear. Consequently, in order that such a heater that two or more peaks of the time derivative of the rate of change in thermogravity of carbon appear may have the NTC characteristic, among the peaks of the time derivative of the rate of change in thermogravity of carbon, the decomposition peak temperature value appearing at first can be 750° C. or lower.

In the above-described evaluation of the temperature rise of the non-sheet passing portion, when envelopes (COM10) were passed at 10 ppm, no abnormality was seen in the surface layer of the pressure roller after sheet passing in Heater Example 1 and Heater Example 2, but in the conventional example, Heater Example 3 and Heater Example 4, the temperature rise of the non-sheet passing portion exceeded the heat resisting temperature 240° C. of the PFA tube on the surface layer of the pressure roller and therefore, the surface layer of the pressure roller was melted, and the surface layer became rough and a reduction in releasability occurred. To avoid this, in the conventional construction, the fixing speed must be dropped to 6 ppm when fixing a recording material of COM10, whereas in Heater Example 3 and Heater Example 4, a fixing speed of 8 ppm is enough and therefore, Heater Example 3 and Heater Example 4 also have superiority to the conventional example.

Also, when in Heater Example 1, the fixing speed when fixing the recording material of COM10 is set to 8 ppm and 6 ppm, and in Heater Example 2 and Heater Example 3, the sheet passing interval of COM10 set to 6 ppm, the highest temperature is suppressed to 210° C. or lower and therefore, the material of the surface layer of the pressure roller can be denatured PFA or FEP more inexpensive than PFA. Such suppression of the highest temperature of the temperature rise also leads to the merit that a member low in heat-resisting temperature and of an inexpensive grade becomes usable as a part of the fixing apparatus. It will be seen that the effect thereof is greater as the value of the rate of change in resistance D(300° C.) at 300° C. becomes smaller (greater on the negative side) than the value 0.155 of the conventional example.

Consequently, as the carbon heat generating member used in the fixing apparatus using a flexible member, the rate of change in resistance D(X° C.) at a predetermined temperature X° C. defined by the following expression is 0.15 or less, and preferably 0 or less, whereby the excessive temperature rise of the non-sheet passing area can be suppressed.
D(X° C.)=[((resistance value when the heater is at X° C.)−(resistance value when the heater is at 20° C.))/(resistance value when the heater is at 20° C.)]

In short, a carbon heat generating member containing graphite and amorphous carbon is utilized as the heat generating member. The single crystal itself of graphite is of the PTC characteristic and the resistance value thereof is very low and therefore, in order to obtain the compatibility of the NTC characteristic and the nationalization of the resistance value in the heat generating member, the heat generating member must be a mixture of graphite and amorphous carbon, and as the manner of mixing, it is preferable that one of the decomposition peak temperature values of TGA be at least 750° C. or lower.

Also, this construction can be realized by doing as follows.

1) The raw material containing an organic matter is sintered at a temperature of 850° C. or higher and 1750° C. or lower in a vacuum or in an inert gas.

2) When the adjustment of the resistance value is necessary, an insulative or semi-electrically conductive substance as an electrical conduction hindering substance is mixed with the raw material.

3) As regard, carbon powder is mixed with the raw material.

If such a heater as described above is adopted in an image heating apparatus in which a fixing nip portion is formed by a heater and a backup member with a flexible member interposed therebetween, there can be provided an image heating apparatus which can suppress the temperature rise of the non-sheet passing portion. Also, if such an image heating apparatus is mounted as the fixing device of an image forming apparatus, it will be possible to suppress a reduction in the number of prints per unit time when small-sized recording materials are printed.

### Embodiment 2

There will now be shown an embodiment which can quicken the rising of the fixing apparatus of the film heating type to a target controlled temperature by using the carbon heat generating member 3 as a heat source. By adopting this embodiment, there is provided a construction effective for types of machines of which shorter FPOT is required.

The conventional heater 30 (FIGS. 11A and 11B) is of a construction in which a resistance heat generating member 30a of Ag/Pd or the like is screen-printed on an alumina ceramic substrate 30b, and is sintered on the substrate 30b.

Alumina ceramics, however, are of high thermal conductivity (thermal conductivity of about 20 W/m·K) and therefore, the heat of the heat generating member 30a is liable to be transferred from the substrate 30b side on the opposite side (non-printing surface side) of the printing surface side (film sliding surface side), or the alumina, ceramic substrate 30b to the surroundings thereof, and a quantity of heat is required to heat the ceramic substrate 30b and therefore, a corresponding time is required for rising.

In the present invention, however, the carbon heat generating member 3 itself is already a plate-shaped single member and therefore, the material of a member contacting with the back surface (non-printing surface side) of the heat generating member 3 can be replaced by other material, i.e., a material of low thermal conductivity.

As in Embodiment 1, by the stay 1 of a liquid crystal polymer (λ=about 1.1 W/m·K) which is a resin member of low thermal conductivity having heat resistance being used as the member contacting with the back surface (non-printing surface side) of the heat generating member, the heat conduction toward the opposite side to the printing surface can also be suppressed and therefore, as compared with the conventional construction, it becomes possible to warn the heat generating member, the film and the pressure roller more efficiently, and the shortening of the rise time is possible, and in the present embodiment, a member of lower thermal conductivity was applied to the back surface of the heat generating member, whereby the further shortening of the rise time was effected.

Specifically, in the present Embodiment 2, as shown in FIG. 12, by the use of the carbon heat generating member 3 of Heater Example 1 in Embodiment 1, the material of the back surface thereof was provided by a PPS resin substrate 14 (the thickness of which is 1.0 mm, and λ=about 0.8 W/m·K).

The rise time of the fixing apparatus of the film heating type actually in each construction is shown in Table 2 below. Incidentally, the rise time mentioned herein is defined as the time required for the temperature of the thermistor of the fixing apparatus of the film heating type in each construction to reach a target controlled temperature from the start of electric power supply.

Also, the target controlled temperature of each construction mentioned herein is defined as follows. In L/L (15° C./10%) environment, a laser beam printer including the fixing apparatus of the film heating type is cooled sufficiently (until it is saturated in the L/L environment), and from that state, the input electric powder is unified at 600 W, and the electric power supply to the fixing apparatus is started, and one second after the thermistor 5 has reached the controlled temperature, Neenah Bond 64 g/m² paper bearing thereon an unfixed image of a solid black pattern of 5×5 mm is passed. The foregoing work was done at intervals of 5° C., and the fixing property of the solid black pattern 5×5 mm at the respective controlled temperatures was examined by a rate of reduction in density using a Macbeth densitometer, and the controlled temperature at which the rate of reduction in density became 10% or less was defined as the target controlled temperature of that construction.

That is, by comparing the rise times in the respective constructions with one another, the times required for warming the respective fixing apparatuses to a state exhibiting an equal fixing property are compared with each other.

TABLE 2
Comparison among Rise Times

| | Embodiment 1 | | |
|---|---|---|---|
| | Construction of Heater | | Conventional |
| | Example 1 | Embodiment 2 | Example |
| heater | liquid crystal polymer | PPS Substrate + | alumina |
| construction | (serving also as film | carbon | substance + |
| | stay) + carbon | resistance | screen |
| | resistance heat | heat | printing heat |
| | generating member | generating | generating |
| | | member | member |
| rise time | 3.4 sec. | 2.9 sec. | 5.9 sec. |

From the result shown above, it can be seen that the rise is quick when the material of the member contacting with the back surface side of the heat generating member is a resin material such as PPS or a liquid crystal polymer. It can also be seen that among the resin materials, the use of PPS which is lower in thermal conductivity than the liquid crystal polymer leads to the quicker rising of the heat-fixing apparatus.

Thus, by using the construction of the present embodiment, it becomes possible to quicken the rising of the fixing apparatus, and it becomes possible to fix the paper more quickly after the print signal has come and therefore, it is also possible to quicken the FPOT of the image forming apparatus.

Of course, the shortening of the rise time can also be achieved as far as a similar material is used for the back surface of the heat generating member in the constructions of Heater Examples 2 to 4 which are other carbon heat generating members than Heater Example 1 in Embodiment 1 shown in the table above.

Thus, by providing a heat-fixing apparatus of a construction in which the material of the member contacting with the non-printing surface side of the carbon heat generating member 3 is resin, it is possible to greatly shorten the rise time of the heat-fixing apparatus to a predetermined temperature during fixing.

Also, by providing a heat-fixing apparatus of a construction in which the member contacting with the non-printing surface side of the carbon heat generating member 3 is provided by the stay 1 as a heat generating member supporting member and film guide member, it is possible to greatly shortening the rise time of the heat-fixing apparatus to the predetermined temperature during fixing and also, it is possible to decrease the number of parts of the heat-fixing apparatus, and simplify the structure thereof.

[Other]

1) Other desired functional layer such as a layer of heat-resistant lubricant can be added to the film sliding surface of the heat generating member 3, as required.

2) The driving method for the film 2 which is a flexible member is not restricted to the pressure member driving method in the embodiments. There may be adopted an apparatus construction in which a drive roller is provided on the inner peripheral surface of an endless flexible member, and the flexible member is driven while tension is applied thereto, or there can be adopted an apparatus construction in which the flexible member is made into the shape of a rolled end-having web, and it is moved while being paid away.

3) The pressure member 6 is not restricted to a roller member, but can also be a rotary belt member.

4) The temperature detecting element 5 is not restricted to a thermistor. Use can be made of one of various types such as a contact type and a non-contact type.

5) The image heating apparatus of the present invention is not restricted to the fixing apparatus of an image forming apparatus, but can also be used as an image heating apparatus for tentatively fixing an image, or an image heating apparatus or the like for reheating a recording medium bearing an image thereon to thereby improve a surface property such as gloss.

This application claims priorities from Japanese Patent Applications No. 2004-323638 filed Nov. 8, 2004 and No. 2005-319529 filed Nov. 2, 2005, which are hereby incorporated by reference herein.

What is claimed is:

1. An image heating apparatus comprising:
a heater generating heat by electric energization;
a flexible member moved while contacting with said heater; and
a backup member cooperating with said heater with said flexible member interposed therebetween to form a nip portion, said image heating apparatus heating a recording material having an image thereon while nipping and conveying the recording material between said flexible member and said backup member,
wherein said heater is made by heat-treating a raw material containing an organic matter in an atmosphere in which carbon is hardly oxidized to carbonize the organic matter.

2. An image heating apparatus according to claim 1, wherein the heater after the heat treatment has graphite and amorphous carbon.

3. An image heating apparatus according to claim 1, wherein the raw material before the heat treatment contains one kind or several kinds of at least insulative or semi-electrically conductive substance.

4. An image heating apparatus according to claim 1, wherein a temperature at which the raw material is heat-treated is 850° C. or higher and 1750° C. or lower.

5. An image heating apparatus according to claim 1, wherein a rate of change in resistance D(X° C.) of said heater is defined as
D(X° C.)=((resistance value when said heater is at X° C.)−(resistance value when said heater is at 20° C.))/(resistance value when said heater is at 20° C.), and
when a temperature of said heater is within a range of 20° C. or higher and 300° C. or lower, the following relationship is satisfied:
D(X° C.)≦0.15.

6. An image heating apparatus according to claim 1, wherein a rate of change in resistance D(X° C.) of said heater is defined as
D(X° C.)=((resistance value when said heater is at X° C.)−(resistance value when said heater is at 20° C.))/(resistance value when said heater is at 20° C.), and
when a temperature of said heater is within a range of 20° C. or higher and 300° C. or lower, the following relationship is satisfied:
D(X° C.)≦0.

7. An image heating apparatus according to claim 1, wherein when said heater is thermogravimetrically analyzed at a temperature rising speed of 10° C./min. in the air, a peak of a time derivative (%/min.) of a rate of change in weight (%) of carbon is at 750° C. or lower.

8. An image heating apparatus according to claim 1, wherein said image heating apparatus is mounted on an image forming apparatus for forming an image on a recording material, said image heating apparatus further comprising a temperature detecting element for detecting a temperature of said heater, and electric power supply controlling means for controlling electric power supply to said heater so that a detected temperature by said temperature detecting element maintains at a set temperature, and wherein in a longitudinal direction of said image heating apparatus, said temperature detecting element detects the temperature of said heater in an area through which a recording material of a minimum fixed size usable in said image forming apparatus passes.

9. An image heating apparatus comprising:
a heater generating heat by electrical energization;
a flexible member moved while contacting with said heater; and
a backup member cooperating with said heater with said flexible member interposed therebetween to form a nip portion, said image heating apparatus heating a recording material bearing an image thereon while nipping and conveying the recording material between said flexible member and said backup member,
wherein said heater is a carbon heat generating member utilizing carbon as an electrically conducting substance, and when said heater is thermogravimetrically analyzed at a temperature rising seed of 10° C./min. in the air, a peak of a time derivative (%/min.) of a rate of change in weight (%) of carbon is at 750° C. or low.

10. An image heating apparatus according to claim 9, wherein said heater has graphite and amorphous carbon.

11. An image heating apparatus according to claim 9, wherein a rate of change in resistance D(X° C.) of said heater is defined as
D(X° C.)=((resistance value when said heater is at X° C.)−(resistance value when said heater is at 20° C.))/(resistance value when said heater is at 20° C.), and
when a temperature of said heater is within a range of 20° C. or higher and 300° C. or lower, the following relationship is satisfied:
D(X° C.)≦0.15.

12. An image heating apparatus according to claim 9, wherein a rate of change in resistance D(X° C.) of said heater is defined as
D(X° C.)=((resistance value when said heater is at X° C.)−(resistance value when said heater is at 20° C.))/(resistance value when said heater is at 20° C.), and
when a temperature of said heater is within a range of 20° C. or higher and 300° C. or lower, the following relationship is satisfied:
D(X° C.)≦0.

13. An image heating apparatus according to claim 9, wherein said image heating apparatus is mounted on an image forming apparatus for forming an image on a recording material, said image heating apparatus further comprising a temperature detecting element for detecting a temperature of said heater, and electric power supply controlling means for controlling electric power supply to said heater so that a detected temperature by said temperature detecting element maintains at a set temperature, and wherein in a longitudinal direction of said image heating apparatus, said temperature detecting element detects the temperature of said heater in an area through which a recording material of a minimum fixed size usable in said image forming apparatus passes.

14. A heater for use in an image heating apparatus, the image heating apparatus having a heater generating heat by electrical energization, a flexible member moved while contacting with the heater, and a backup member cooperating with the heater with the flexible member interposed therebetween to form a nip portion,
wherein said heater is a carbon heat generating member utilizing carbon as an electrically conducting substance, and when said heater is thermogravimetrically analyzed at a temperature rising speed of 10° C./min. in an air, a peak of a time derivative (%) of a rate of change in weight (%) of carbon is at 750° C. or lower.

15. A heater according to claim 14, wherein said heater is made by heat-treating a raw material containing an organic matter in an atmosphere in which carbon is hardly oxidized to carbonize the organic matter.

16. A heater according, to claim 15, wherein said heater after the heat treatment has graphite and amorphous carbon.

17. A heater according to claim 15, wherein a raw material before the heat treatment contains one kind or several kinds of at least insulative or semi-electrically conductive substances.

18. A heater according to claim 15, wherein a temperature at which the raw material is heat-treated is 850° C. or higher and 1750° C. or lower.

19. A heater according to claim 14, wherein a rate of change in resistance D(X° C.) of said heater is defined as
D(X° C.)=((resistance value when said heater is at X° C.)−(resistance value when said heater is at 20° C.))/(resistance value when said heater is at 20° C.), and
when a temperature of said heater is within a range of 20° C. or higher and 300° C. or lower, the following relationship is satisfied:
D(X° C.)≦0.15.

20. A heater according to claim 14, wherein a rate of change in resistance D(X° C.) of said heater is defined as
D(X° C.)=((resistance value when said heater is at X° C.)−(resistance value when said heater is at 20° C.))/(resistance value when said heater is at 20° C.),
when a temperature of said heater is within a range of 20° C. or higher and 300° C. or lower, the follosing relationship is satisfied:
D(X° C.)≦0.
